(19) United States
(12) Patent Application Publication
(10) Pub. No.: US 2012/0233550 A1
(43) Pub. Date: Sep. 13, 2012

(54) TOOLS TO CONVEY MEDIA CONTENT AND COST INFORMATION

(75) Inventor: Andrew Jay Zimmon, Groton, MA (US)

(73) Assignee: Wave2 Media Solutions, LLC

(21) Appl. No.: 13/044,479

(22) Filed: Mar. 9, 2011

(51) Int. Cl. G06F 3/01

(52) U.S. Cl. 715/744

(57) ABSTRACT

In accordance with one aspect of the present disclosure, apparatus are provided, including a media submitter user interface, media stored data, a media receiver, and a layout adjuster. The media submitter user interface presents information to prompt a media submitter to enter given media content and parameters of the media content, thereby specifying a media layout to be submitted to a publisher for publication. The media stored data represents a field for holding the given media content. The media submitter user interface is configured to access the field and to display a graphical representation of the field with the given media content, allowing the media submitter to make, further alterations to the media content and also allowing the media submitter to review the given media content. The media receiver receives and stores the given media content. The layout adjuster evaluates the given media content and determines space and layout requirements. The layout adjuster also adjusts the dimensions of a layout incorporating the media content in a form that mirrors an appearance of the media layout upon publication.

### FIELD OF THE DISCLOSURE

One or more aspects of the present disclosure relate to networked interfaces that allow non-publisher users to configure and submit media content publications, the dynamic presentation of media content for publication, and the facilitation of easy preparation of media content for publication by users.

### DESCRIPTION OF BACKGROUND INFORMATION

Publications may use print media such as newspapers, magazines, circulars, newsletters, bulletins, and menus, and online media, for example, on the internet. These publications allow customers to submit their own media content for inclusion in the publication. For example, the general public may submit obituaries, celebration announcements, legal notices, real estate ads, business advertisements, want ads, and classified advertisements.

Publications accepting media content may charge customers a fee for publishing the media content. Various criteria may be used in calculating this fee, such as the type of content included in the publication (e.g., text, photograph, graphical design), the location within the publication where the submission will be placed, and the amount of space the submission will use in the publication.

The process of submitting media content for publication frequently requires that the customers contact a representative of the publication, and discuss a number of media content publication parameters, including, among others, the likely content of the submission, price factors, and availability of space in the publication.

### SUMMARY OF THE DISCLOSURE

In accordance with one aspect of the present disclosure, apparatus are provided, including a media submitter user interface, media stored data, a media receiver, and a layout adjuster. The media submitter user interface presents via a media submitter computer screen, information to prompt a media submitter to enter given media content and parameters of the media content. This thereby specifies a media layout to be submitted to a publisher for publication. The media stored data represents a field for holding the given media content. The media submitter user interface is configured to access the field and to display a graphical representation of the field with the given media content. This allows the media submitter to make, via computer screen input, further additions and changes to the given media content. It also allows the media submitter to review the given media content, including text to be submitted as part of the specified media layout.

The media receiver receives the given media content into the field via the media submitter computer screen, and stores the given media content. The layout adjuster evaluates the given media content in the field, and thereby determines space and layout requirements of the given media content. The layout adjuster also adjusts the dimensions of a layout incorporating the given media content in a form that mirrors an appearance of the specified media layout upon publication.

The details of the information entered and/or selectable by the user and of the logic of the program script are presented below.

### BRIEF DESCRIPTION OF THE DRAWINGS

Embodiments of the disclosure are further described in the detailed description which follows, by reference to the noted drawings, in which like reference numerals represent similar parts throughout the several views of the drawings, and wherein:

FIG. 1A is a block diagram of an embodiment of a media submission system;

FIG. 1B is a flow chart of an embodiment of a media submission process;

FIG. 2 is a schematic of one embodiment of a login interface;

FIG. 3 is a schematic of one embodiment of an identification interface;

FIG. 4 is a schematic of one embodiment of a publication selection interface;

FIG. 5 is a schematic of one embodiment of a media category selection interface;

FIG. 6 is a schematic of one embodiment of a classification and package interface;

FIG. 7 is a schematic of one embodiment of a template selection interface;

FIG. 8 is a schematic of one embodiment of a media content customization interface;

FIG. 9 is a schematic of one embodiment of a proof interface;

FIG. 10 is a schematic of one embodiment of a media content scheduling interface.

FIG. 11A is a flow chart of one embodiment of a script to be run for dynamic sizing of the media content and for correctly placing, within the media content publication, the information input by the user.

FIG. 11B is a flow chart of one embodiment of template instructions.

FIG. 11C is a flow chart for creation of one embodiment of statistical data for booking, sizing, and pricing the media content publication.

### DETAILED DESCRIPTION

Certain terms used herein may be defined, for example, in embodiments herein, as follows. Media layout in embodiments herein, may refer to the size, shape, and location of an area (may or may not be contiguous), in a publication's “real estate”, within which media (e.g., media of an advertisement, per some embodiments) is positioned and constrained.

Publication submission in embodiments herein, may refer to the information, including, for example, text, photographs, graphics, font, and information specifying preferences with respect to media layout, which is submitted for publication by the user.

Sizing in embodiments herein, may refer, for example, to the adjustment of the length, width, or number of columns allotted to the text, photographs, graphics or other objects within the media content submission, or for the publication submission as a whole.

Apparatus, methods, and non-transitory computer readable media are provided which allow for the networked iterative configuration (and reconfiguration) by a user of a publication submission in the form of a layout and media within that layout. The user may be a customer of the publisher, who need not be a professional publisher or a representative of professional publishers, and who is generally not familiar with the design, sizing, layout configuring, scheduling, publication and/or pricing of publication submissions. Exemplary media content include display advertisements such as obituaries, celebration announcements, real estate ads, legal notices, business advertisements, want ads, and classified advertisements for goods or services.

Embodiments disclosed herein, including apparatus, non-transitory computer readable media, and methods, allow users to design and schedule a presentation of media content for publication without assistance. The user is able to select, for example, in which publication or publications the user would like the submitted media content to be published and what type of media content the user would like to submit (e.g., obituary, classified ad, etc.). The user may also select a template which the user can use to design the submission, and fields in which the user is able enter the content of the submission.

The layout of the media content is presented to the user via a computer screen rendition. The computer screen rendition represents the media content as it will appear in the final publication. The displayed rendition presented to the user changes dynamically in real-time as publication options are selected or de-selected and as media content is chosen, entered, or altered by the user.

A final graphic or media file representing the media content may be produced, which can be stored, uploaded, sent, and/or presented to the user's computer screen. For example, the system can produce a pdf, JPEG file, EPS file, RTF, XML and other text based formats representing the media content as it will appear when published in the publication.

The user may enter publication scheduling information for each publication in which the media content is to be published.

Considering the media content, scheduling, and presentation options chosen by the user, and also considering the pricing criteria of the publication or publications chosen for submission by the user, price information may be automatically generated and presented to the user. Such pricing information can change dynamically in real-time as publication options are selected or de-selected by the user and as media content is chosen, entered, or altered by the user.

In some embodiments, a fixed sized template of the media content publication is first created. Next, a program script is run to automatically, without human intervention, communicate with a media publishing engine to both size and correctly place all of the media content supplied by the user according to the instructions supplied by the user.

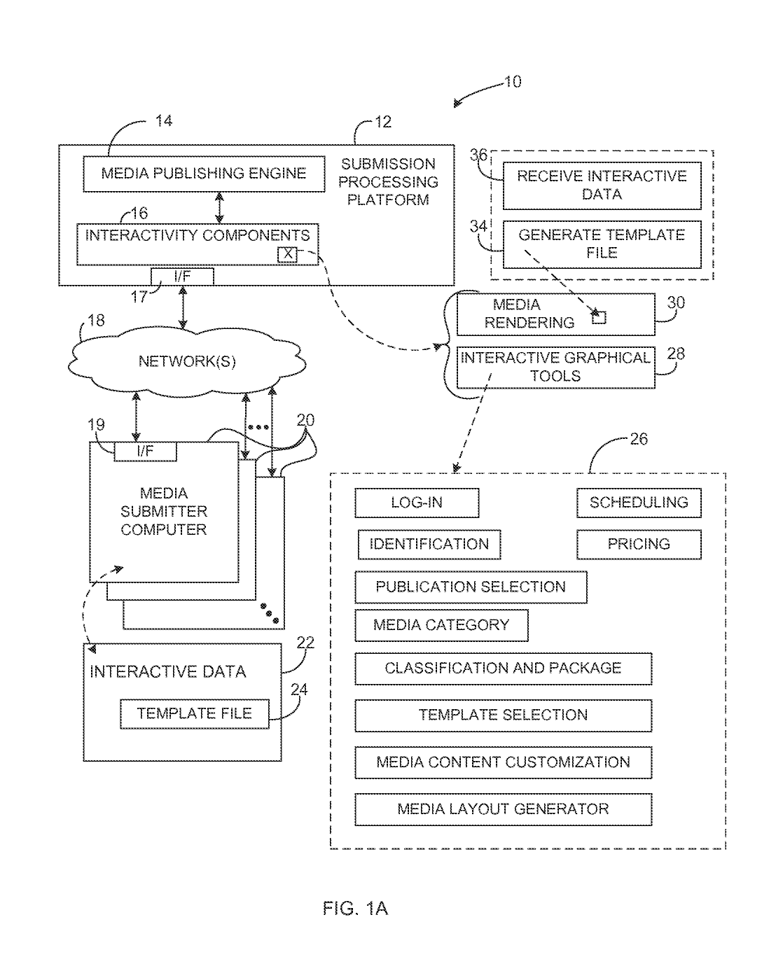

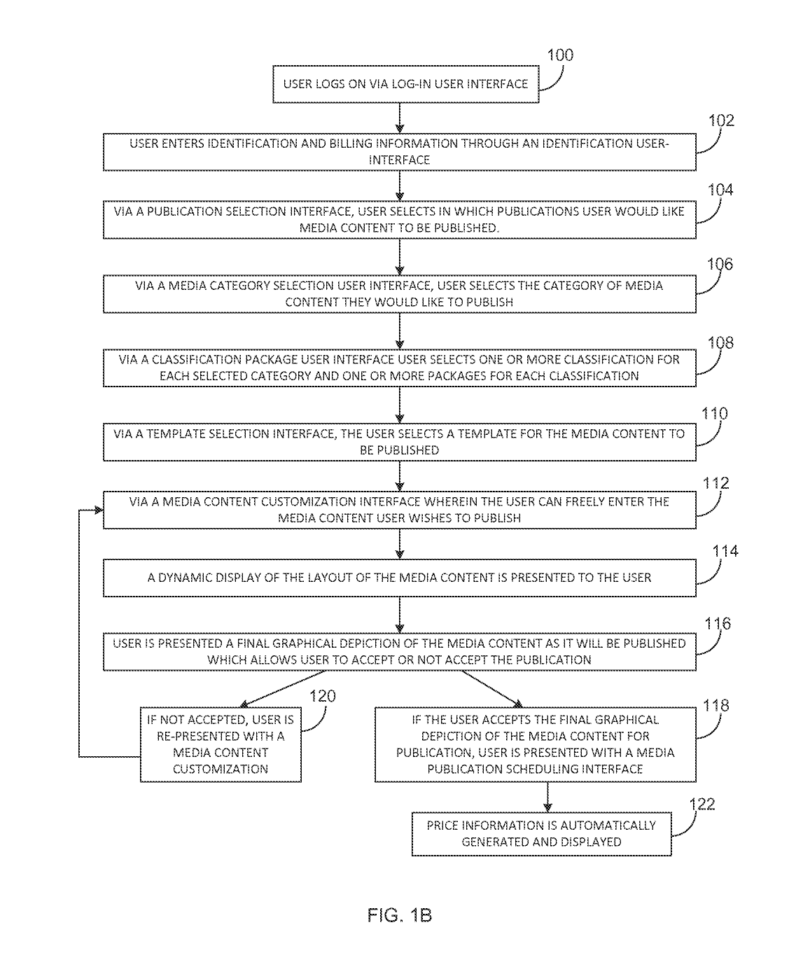

Referring now to the drawings in greater detail, FIG. 1A is a block diagram of an embodiment of a media submission system 10. One aspect of the disclosure concerns allowing users to submit media content to publishers for publication of the media content, where the users are individuals that need not be familiar with the design, sizing, layout, scheduling, publication and/or pricing of publication submissions.

The illustrated media submission system 10 includes a media submitter computer 20 which comprises a user interface 19. The media submitter computer 20 inputs and receives interactive data 22 including a template file 24.

The illustrated media submission system 10 also includes a submission processing platform 12 which comprises a media publishing engine 14, interactivity components 16, and an interface 17.

In the illustrated embodiment, via the interface 19, the media submitter computer 20 communicates through one or more networks 18 with an interface 17 on a submission processing platform 12.

In the illustrated embodiment, the interactivity components 16 include media rendering tools 30 and interactive graphical tools 28. The interactive graphical tools, per the illustrated embodiment, comprise various graphical user interface mechanisms 26 through which a user can enter and receive information about the publication submission.

In the illustrated embodiment, the graphical user interface mechanisms 26 may be presented to a user on a media submitter computer 20 via an interface 19. In the illustrated embodiment, the media rendering tools 30 receive the interactive data 36 and generate a template file 34.

In the illustrated embodiment, the interactivity components 16, including the media rendering 30 and interactive graphical tools 28 communicate with a media publishing engine 14 on the submission processing platform 12 to create a final publication of the publication submission.

FIG. 1B is a flow chart depicting the various parts of the apparatus presented to a user in an embodiment of the disclosure.

A login Interface 100 may be presented to the user which allows the user to enter the system. An identification interface 102 may be presented in which a new user may enter identification information and billing information.

A publication selection interface 104 may be presented which allows the user select the publication or publications in which the user would like the media content to be published.

A media category selection interface 106 may be presented which allows a user to select category of media content the user would like to publish.

A classification and package interface 108 may be presented which allows the user to select from one or more media content classifications and from one or more media content packages.

A template selection interface 110 may be presented which indicates, for selection by the user, one or more templates available for publishing the media content.

A media content customization Interface 112 may be presented which allows the user to enter the media content the user wishes to be published.

A dynamic display 114 of the media content may also be presented to the user, which represents the appearance of the media content in the final publication, and which changes in approximately real-time as the user enters, removes, or alters the media content.

A final graphical depiction 116 of the media content to be published may also be presented to the user in order to allow the user a final review of the media content as it will appear in the publication before the user approves the publication.

If the user does not approve the publication as it appears, the user may be permitted to return to any prior step (e.g., the media content customization interface 112 per the illustrated embodiment) in order to alter the content of the media for presentation or to alter the presentation of the media 120. If the user does approve of the publication as it appears in the final graphical depiction 116, a media publication scheduling interface 118 may be presented which indicates, for selection by the user, for example, the publication purchase options and availability dates for each of the publications selected by the user via the publication selection interface 104.

A price indicator 122 presents the price of publication for the selected publication schedule of the media content as designed by the user. The price information may be automatically generated and presented for each of the publications selected by the user for publication of the media content, based on the media content and design features entered or selected by the user, and also based on the pricing information for the selected publications, purchase options, and schedules selected by the user. Such pricing information may be calculated and presented to the user at any point in the process, and the presentation of the pricing information may change dynamically in approximately real-time as the user enters, removes, or edits the media content, design, or selected publications.

The order of the steps presented in FIG. 1B may be altered, combined and/or rearranged to any other order effective for entering, designing, and publishing the media content. Any steps unnecessary for the entering, designing, and publishing of the media content may be omitted.

At any point, the user may be permitted to go back to any prior step to enter, remove, alter, or edit the media content, design, or publication information.

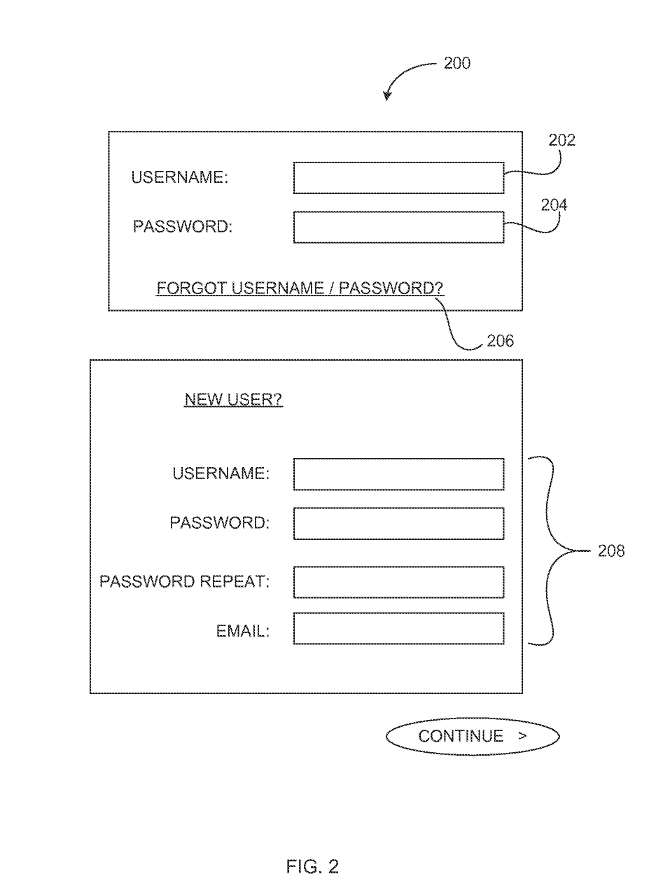

An embodiment of the login interface 200 illustrated in FIG. 2 may include a mechanism, such as a free-form field, to enter an assigned user name 202 and password 204. A mechanism in which information is provided to allow for the generation of a user account and the assigning of a username and password to a given user is also provided 208, as well as for accessing a forgotten username of password 206.

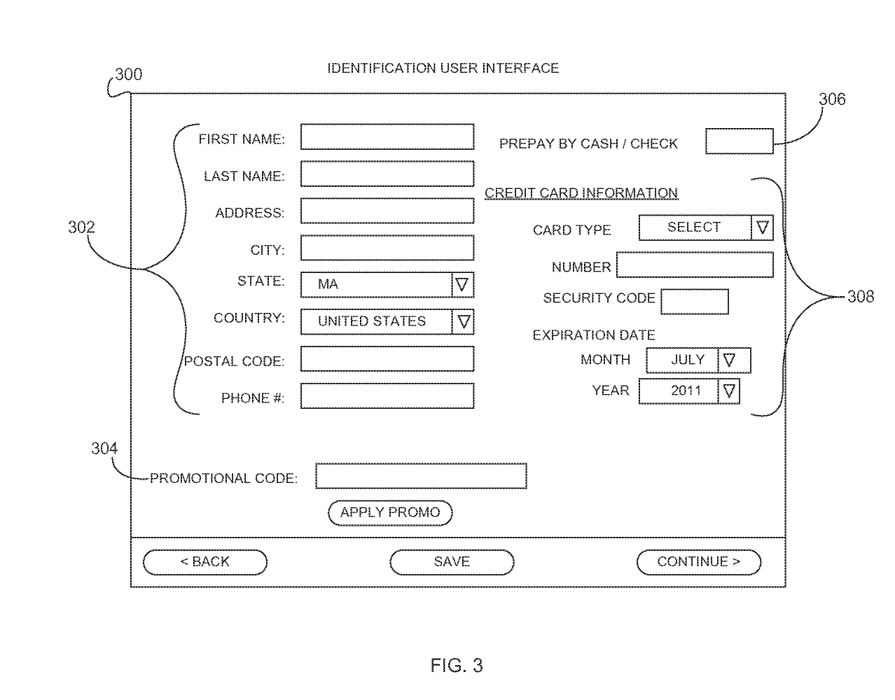

An embodiment of the identification user interface 300 is depicted in FIG. 3. The Identification User Interface 6 provides a mechanism or mechanisms, such as free-form fields or selectable dropdown lists, which allow the user to enter identification and contact information 302. A mechanism or mechanisms may also be provided which allow the user to enter any promotional code 304, payment by cash or check 306, or credit card billing information 308.

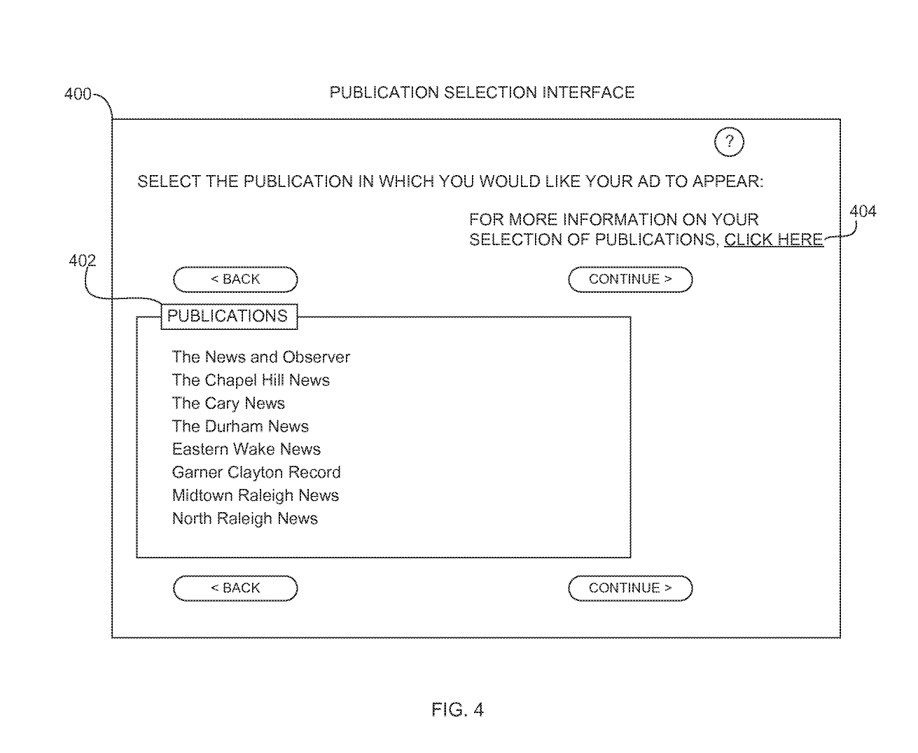

An embodiment of the publication selection interface 400 is depicted in FIG. 4. The publications available for publication of the media content are presented, for example, in a field 402. From among the presented publications, the user may select one or more publications in which the user would like to publish the media content. Information regarding the publications, for example circulation size, reader demographics, scheduling, and pricing, may be made available to the user, for example, via a link 404.

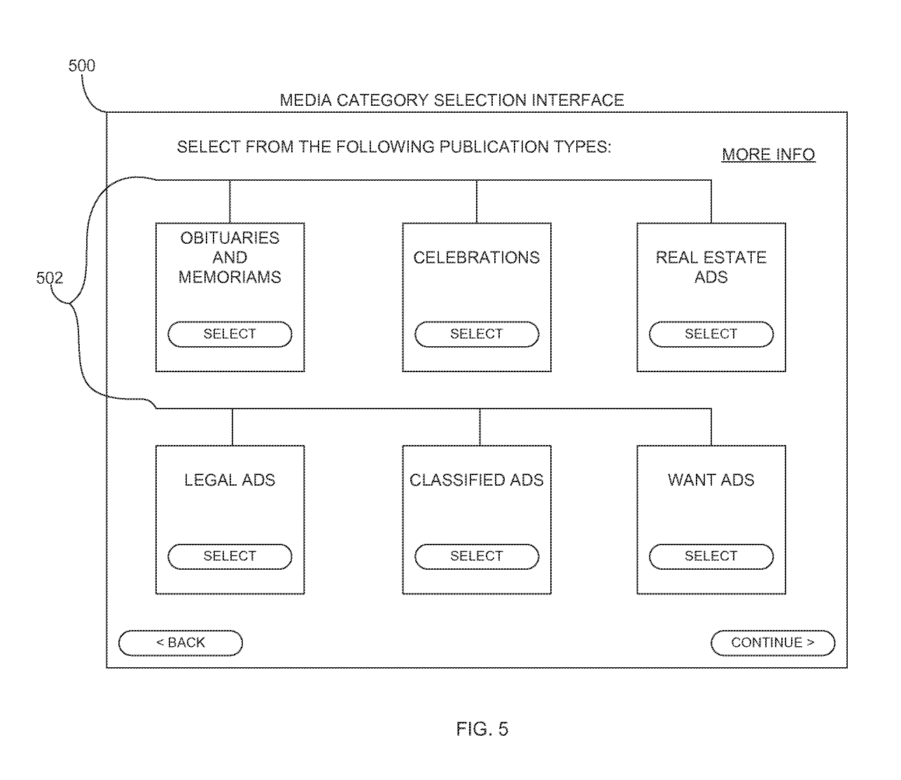

An embodiment of the media category selection interface 500 is presented in FIG. 5. One or more various types of publications 502 are presented for selection by the user. The media categories presented for selection by the user are those categories available for the publication or publications selected by the user via the publication selection interface 11 and/or other information entered or selections previously made by the user. Such publication types may include, among others: obituaries and memorials; celebration announcements; real estate advertisements, legal advertisements or notices, classified advertisements; and/or help wanted advertisements. Information regarding each type of publication, such as ordinary content, template options, pricing, and examples, may be made available through a link.

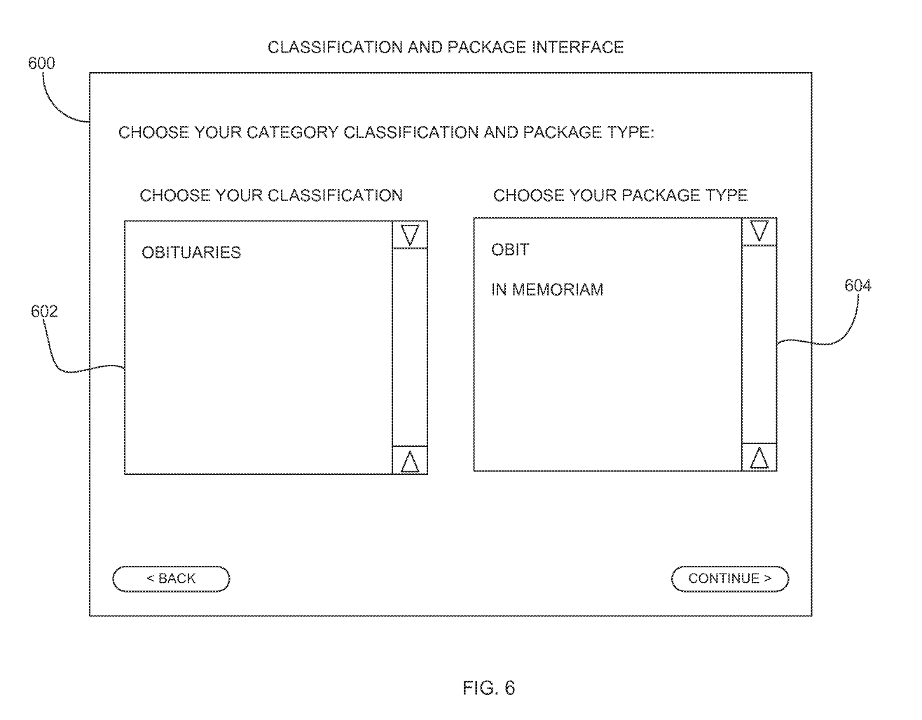

An embodiment of a classification and package interface 600 is depicted in FIG. 6. Classifications of publications are presented for selection by the user via, for example, a category selection field 602. The classifications presented for selection by the user are the classifications available for the media category selected by the user via the media category selection interface 500 and/or other information entered or selections previously made by the user.

One or more package types may also be presented to the user for selection by the user via, for example, a package selection field 604. The package types presented for selection by the user are those packages available for the classification selected by the user via the classification selection field 602 and/or other information entered or selections previously made by the user.

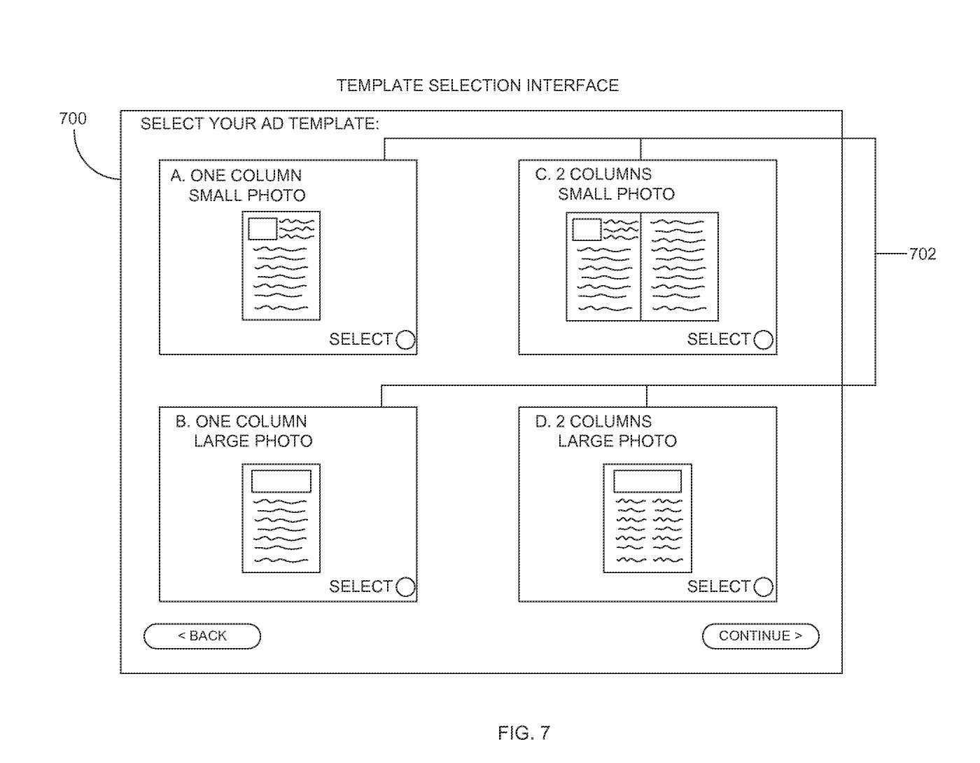

An embodiment of the template selection interface 700 is presented in FIG. 7. The template selection interface 700 presents one or more template options 702 for selection by the user. The template options 702 presented for selection by the user are those templates available for the classification and package selected by the user via the classification and package interface 600 and/or other information entered or selections previously made by the user.

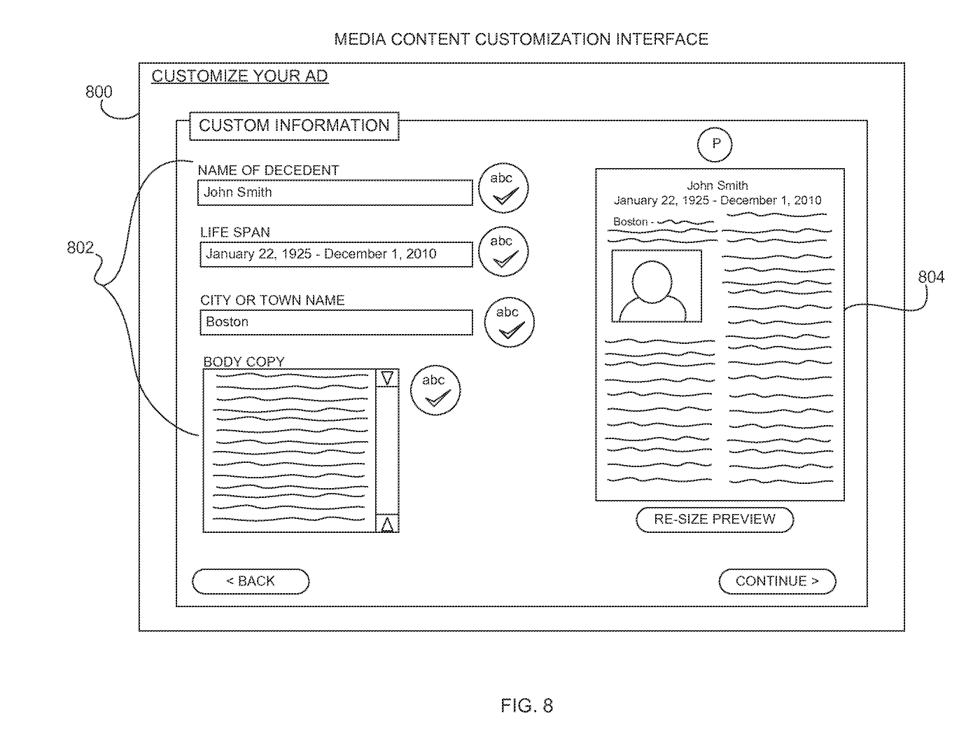

An embodiment of a media content customization interface 800 is depicted in FIG. 8. One or more labeled free-form fields 802 are presented to the user. The labels on the free form fields assist the user in the design and creation of the media content to be published. The number and labels of the free-form fields 802 presented to the user are supplied based on the template selected by the user via the template selection interface 700 and/or other information entered or selections previously made by the user. The free-form fields 802 may be substituted for by other means which assist the user in entering appropriate information, such as drop-down boxes or otherwise selectable options.

A dynamic display 804 of the media content publication is presented to the user. The dynamic display 804 provides a preview (in one embodiment, the preview is an exact representation of the ultimately published media, perhaps with a different resolution than the representation presented on the proof interface 900) of the appearance of the media content as it will appear in the final publication. The dynamic display 804 changes in approximately real-time as the user enters, removes, or edits the media content in the free-form fields 802. The dynamic display can also be presented separate from the media content customization interface 800 or any other interface in order to allow the user to view the effects of changes in other criteria (e.g., template, package, classification, type, or publication) on the appearance of the publication of the media content.

In some embodiments of the media content customization interface, optional graphics (not shown) such as pictures, diagrams, or special effects may be presented for selection by the user. The user may edit the style, including the font, of the media content entered and may alter the border and colorspace of the media content publication. The user may also be presented with an option of uploading text, a photograph, or other graphics or special effects for inclusion in the media content for publication. Such options may also be presented for selection by the user at various other stages of design, including at the template selection interface 700.

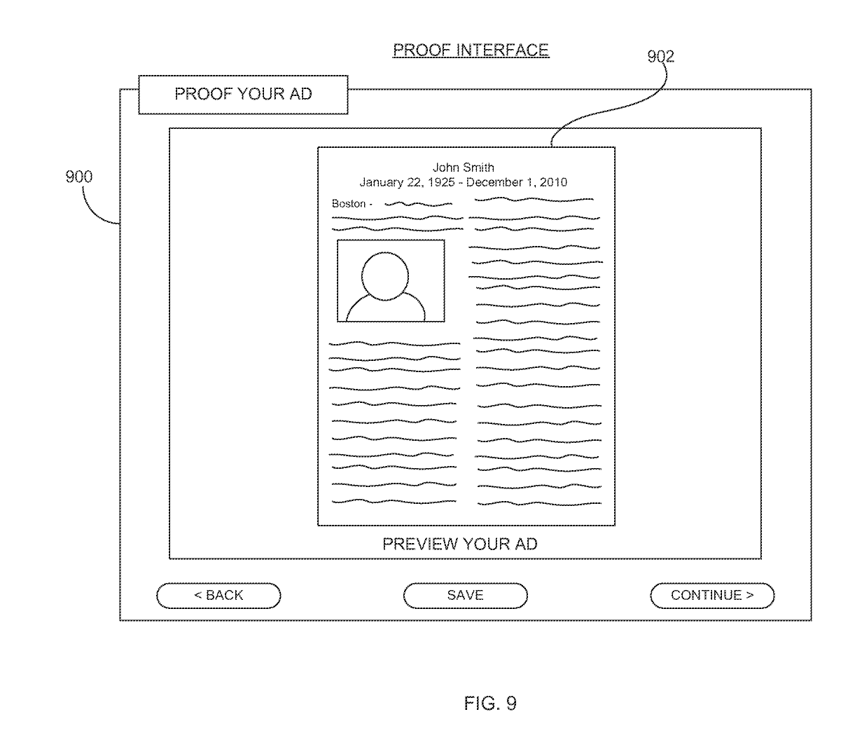

An embodiment of a proof interface 900 is presented in FIG. 9. The Proof Interface 900 presents a graphical depiction 902 of the media content to be published exactly as it will appear in the selected publication or publications. The graphical depiction may be, for example, a pdf document. The graphical depiction 902 of the media content may be marked in some way, for example a watermark, that ensures that it will not be used for publication in publications not selected or selectable by the user, or published in any manner other than publication in the publication or publications selected by the user.

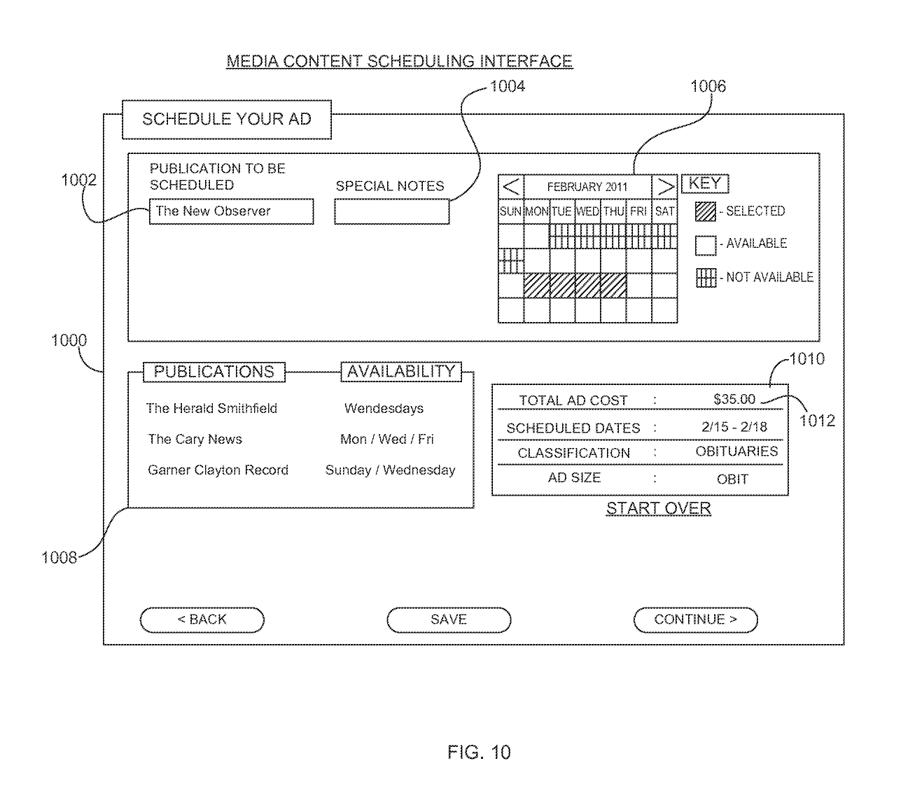

An embodiment of a media content scheduling Interface 1000 is depicted in FIG. 10. A listing of the publication or publications selected by the user via the Publication Selection Interface 400 may be presented to the user in a publications field 1008. The publications field may also show when publication is available for each publication based, at least in part, on the media content to be published.

Upon selecting a publication from the publication field 1008, the selected publication may be presented in the selected publication field 1002. A notes field 1004 may be presented to the user that allows the user to enter special notes, requests, or instructions regarding the publication of the media content.

A calendar 1006 may be presented to the user which may show the dates available for publication of the media content in the selected publication and allows the user to select dates for publication.

A summary field 1010 is presented to the user which summarizes pertinent publication information. Included in the summary field 1010 may be a price information display which displays the price for publication of the media content as designed and in the selected publications on the selected dates.

As the information regarding different text areas, graphics, color choices, images, special effects, column design, and other design choices, etc. (all of which are optional) for the publication of the media content is entered and/or selected by the user (as is depicted in FIGS. 1-10 and described above), that information is used in order to first create a publication file which is either a field which makes no consideration for size, shape, or layout information whatsoever, is of a fixed size, or is of a variable size but which varies in a manner unrelated to the ultimate layout of the media content publication.

This first created publication file may be a generic publication file, such as an ADOBE® INDESIGN® file, that contains the basic structure of the publication with special tags or instructions which describe how different elements or objects within the publication are to be placed and aligned.

A program script is then run which dynamically sizes the media content publication and correctly places all of the media content and design elements supplied by the user according to the instructions in the generic fixed-sized publication file. The program script may be run on non-transitory computer readable media.

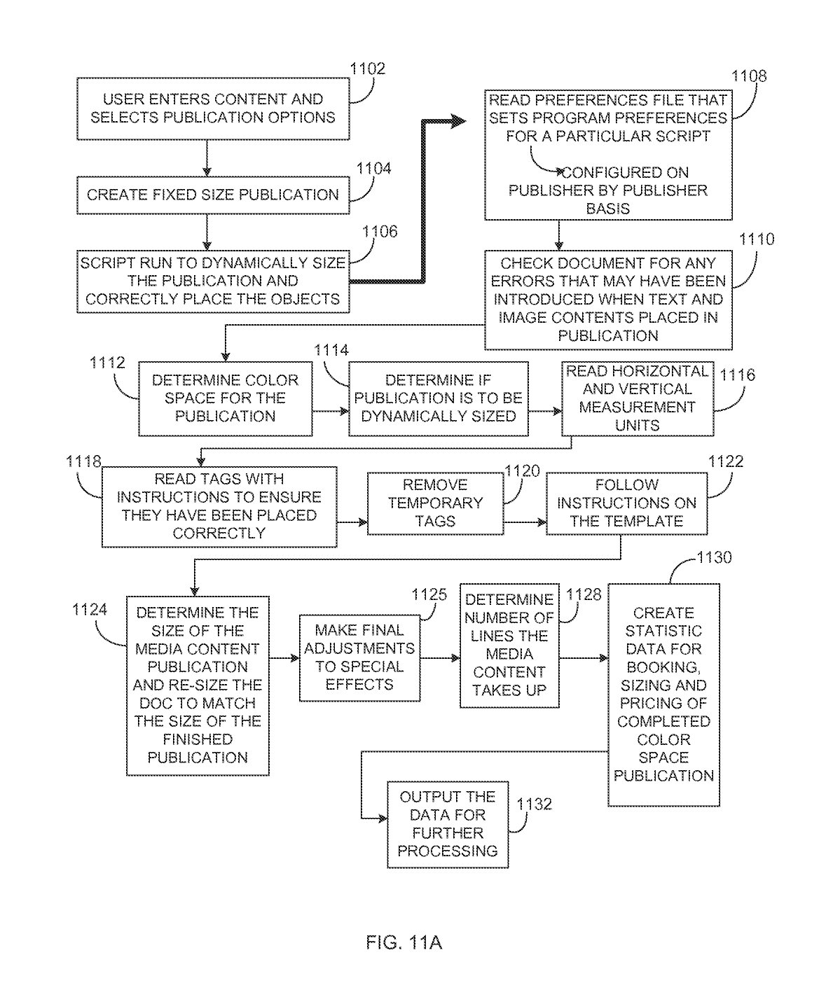

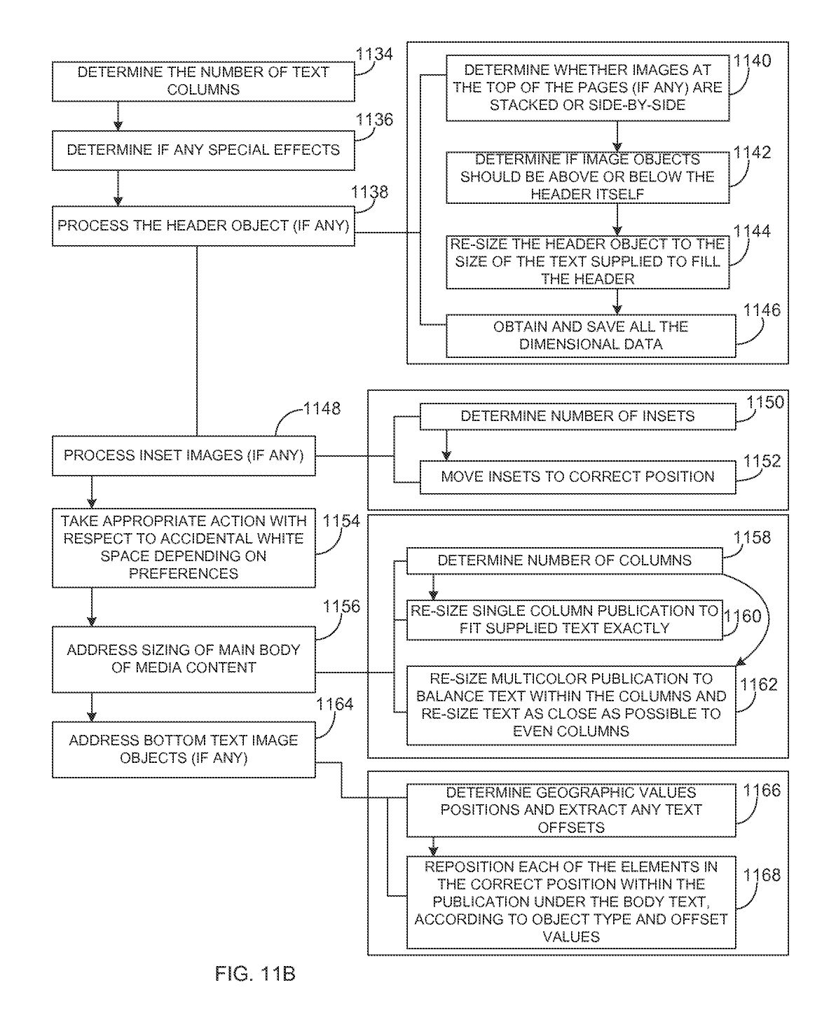

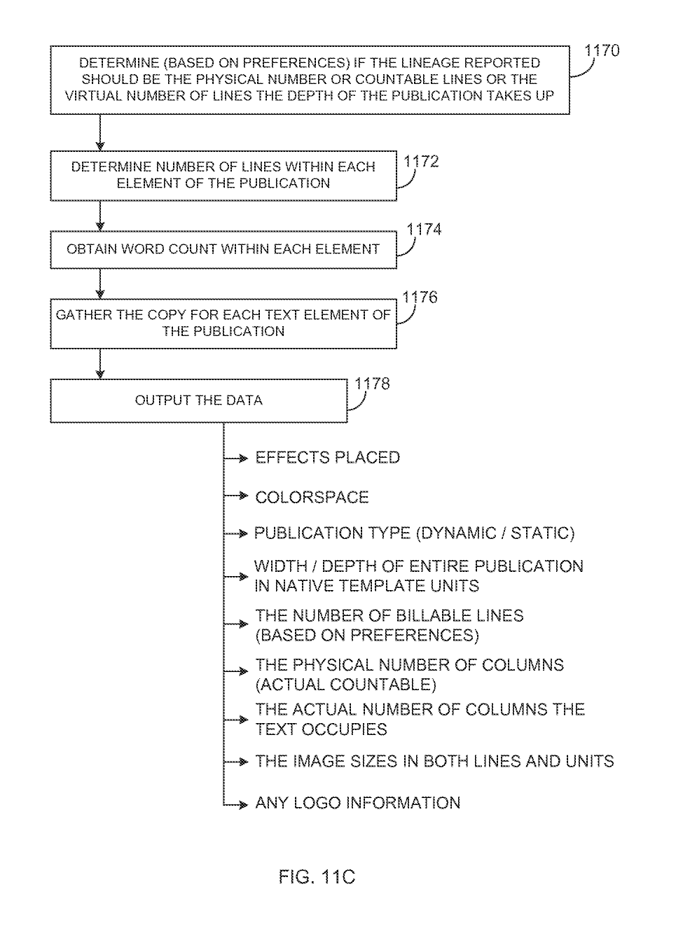

An embodiment of a flow chart for the logic of such a program script is presented in FIGS. 11A-11C.

As per an embodiment as depicted in FIG. 11A, a user may first enter content and select design and publication options 1102. Using the information entered and selected by the user, a fixed-sized publication file may be created 1104. Using the instructions on the fixed-sized publication file, a computer program script may be run which dynamically sizes the media content publication and correctly places all of the media content and design elements supplied by the user according to the instructions in the generic fixed-sized publication file 1104.

The program script may first read the preferences file, which is configured on a publisher-by-publisher basis and which sets the program preferences for a particular script 1108.

The media content may then be checked for errors that may have been introduced when text, image, or other content was entered by the user 1108.

In a next step, the colorspace of the media content may be determined 1112. This information may be used later for determining output statistics.

A determination may then be made as to whether the publication is to be dynamically sized 1114, the horizontal and vertical measurement units may be read 1116, and the tags and/or instructions may also be read 1116 in order to ensure that they have been implemented correctly. Certain tags may only be placed on one object while other tags can be applied multiple times such as an inset enhancer (e.g., a cross, an american flag, etc.).

Any temporary tags, which were placed to provide instruction only and are not part of the final publication, may then be removed 1120.

Next, the program may follow the instructions found within the file 1122.

A flow chart depicting an embodiment of the program logic for following the instructions found within the program file is presented in FIG. 11B and an early step may be the program determining the number of text columns 1134.

In a next step, the program may determine whether the publication includes any special effects 1136. Such effects may include: borders, shading, drop shadows, bolding to any graphic or text, or any other font or formatting changes to all or a portion of the publication. In the case of internet publications, such special effects may also include animation.

In a next step, the program may determine whether there is a header object and, if there is, processes the header 1138. Processing the header may include determining whether there are any images at the top of the publication and, if there are more than one, their relative positions, e.g., stacked or side-by-side 1140. In a next step, the program may determine whether the top objects should appear above the header itself 1142. The header object may then be re-sized to the size of the text used to fill the header 1144. All of the header dimensional data may then be obtained and saved so that additional objects can be placed correctly in relation to the position and dimensions of the re-sized header 1146.

In a next step, any inset images may be processed 1148. This may be done by determining the number of insets 1150. Insets are typically placed within the body text and are placed a fixed number of text lines deep within the publication. The type and size of the header data can effect where the insets are placed. Therefore, the program may determine how far down the publication each inset belongs and notes the offset values. The insets may be moved into their respective correct positions within the publication 1152.

In a next step, the program may take appropriate action, depending on the preferences as indicated by the user, with respect to accidental whitespace such as multiple line returns or multiple tabs which may have been accidentally entered by the user 1154.

The program may next address the sizing of the main body media content 1156. This may be done by determining the number of columns 1158,and either re-sizing any single column publication to fit the supplied text exactly, 1160, or re-sizing any multiple column publication in order to balance the text within the columns and re-size the supplied text as closely as possible in order to even the columns 1162.

Any bottom text and/or image objects may also be processed by the program 1164. This may be accomplished by determining the geographical values and positions of any bottom text or objects and extracting any text offsets 1166. Each of the elements within the publication may be re-positioned into the correct positions within the publication and under the body text according to the object and offset values 1168.

Returning now to FIG. 11A, the program may determine the size of the entire publication and re-size the entire document to match the size of the finished publication 1124. Final adjustments to special effects may also be made 1125, and the number of lines of space taken up by the media content may be determined 1128.

The program may also create statistical data for scheduling, sizing, and pricing of a completed publication 1130. Such statistical data can be created in an XML or similar language to structure, store and transport information.

An embodiment of the creation of the statistical file is depicted in FIG. 11C, and may be accomplished by determining, for example (based on the preferences indicated by the user), if the lineage reported should be the physical, countable, number of lines taken up by the publication, or the virtual number of lines taken up by the publication 1170. The number of lines within each element of the publication may also be determined 1172, and a determination of the word count within each element of the publication may also be made 1174, as well as a gathering the copy for each text element of the publication 1176.

The statistical data is then output in XML or a similar format 1178. The output data may include, for example: effects placed within the publication (which is important for pricing); the colorspace for the publication (e.g., color, grayscale, or unknown); the publication type (e.g., dynamic or static); the width and depth of the entire publication in native template units (e.g., inches, picas, millimeters, etc.); the number of billable lines (based on the preferences indicated by the user); the physical number of columns (actual, countable columns); the actual number of columns occupied by text; the image sizes in both lines and native template units; and any logo or graphical information.

Media content is the content entered by the user for publication, including: graphics, special effects, photographs, and text whether in a header, footer, main body or any other area or position within the design to be published. Such media content selected for publication may include display advertisements such as obituaries, celebration announcements, real estate ads, legal notices, business advertisements, want ads, and classified advertisements for goods or services.

The apparatus and methods presented herein may be internet-based, or may be on a closed network or system. The term networked encompasses connections over the internet as well as connections over other networks such as an intranet.

Media content design includes, for example, the sizing, arrangement, color, special effects, formatting, and font of the media content.

Objects include any items included in the media content, such as images, graphics, headers, footers, special effects, formatting, and text.

Publication may include, for example, placement of the media content in newspapers, magazines, circulars, newsletters, bulletins, menus, electronic displays, billboards, and various publications on the internet.

The computer interfaces illustrated in the figures include certain graphical tools, for example, icons or otherwise manipulable graphical tools. These tools may include displayed information as well as fields for inputting information into a computer system.

The processes or functions performed by the elements shown in the figures herein may be performed by a general purpose computer and/or by a special purpose computer. Such processing or functions may be performed by a single platform or by a distributed processing platform. Any data handled in such processing or created as a result of such processing can be stored in any type of memory. By way of example, such data may be stored in a temporary memory, such as in the random access memory of a given computer. In addition, or in the alternative, such data may be stored in longer-term storage devices, for example, magnetic disks, optical disks, and so on. For the disclosure herein, computer-readable media may include any form of data storage mechanism as well as hardware and circuit representations of the structures or data that a data storage mechanism might represent.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a media submitter user interface configured to present, via a media submitter computer screen, information to prompt a media submitter to enter given media content and parameters of the media content, to thereby specify a media layout to be submitted to a publisher for publication;
media stored data representing a field for holding the given media content, wherein the media submitter user interface is configured to access the field and to display a graphical representation of the field with the given media content, to allow the media submitter to make, via computer screen input, further additions and changes to the given media content, and to allow the media submitter to review the given media content, wherein the media content includes at least one of text and graphics to be submitted as part of the specified media layout;
a media receiver configured to receive the given media content into the field via the media submitter computer screen, and configured to store the given media content; and
a layout adjuster configured to evaluate the given media content in the field, and thereby determine space and layout requirements of the given media content, and further configured to adjust dimensions of a layout incorporating the given media content in a form that mirrors an appearance of the specified media layout upon publication.

2. The apparatus according to claim 1 wherein the media submitter user interface is an networked user interface.

3. The apparatus according to claim 1 wherein the publisher is remote from the media submitter computer screen.

4. The apparatus according to claim 1, wherein the field is part of a fixed-size template.

5. The apparatus according to claim 1 wherein the field for holding and displaying media content for input and review is part of an ADOBE INDESIGN® file.

6. A method for submitting media content for publication, the method comprising:
submitting, via a media submitter user interface presented on a media submitter computer screen, information to prompt a media submitter to enter media content and parameters of the media content, to thereby specify a media layout to be submitted to a publisher for publication;
storing media data representing a field for holding the given media content, wherein the media submitter user interface is configured to access the field and to display a graphical representation of the field with the given media content, to allow the media submitter to make, via computer screen input, further additions and changes to the given media content, and to allow the media submitter to review the given media content, wherein the media content includes at least one of text and graphics to be submitted as part of the specified media layout;
receiving, via a media receiver, the given media content into the field via the media submitter computer screen, and storing the given media content; and
evaluating the given media content in the field and thereby determining the space and layout requirements of the given media content, and adjusting the dimensions of a layout incorporating the given media content in a form that mirrors an appearance of the specified media layout upon publication.

7. The method according to claim 6 wherein the media submission is made via a network.

8. The method according to claim 6 wherein the media submission is made to a publisher that is remote from the media submitter computer screen.

9. The method according to claim 6, wherein the media data is stored in a field that is part of a fixed-size template.

10. The method according to claim 6 wherein the media data is stored in a field that is part of an ADOBE® INDESIGN® file.

11. Computer readable media configured to cause:
a media submitter user interface to present, via a media submitter computer screen, information to prompt a media submitter to enter given media content and parameters of the media content, to thereby specify a media layout to be submitted to a publisher for publication;
storage of media data representing a field for holding the given media content,
display of a graphical representation of the field with the given media content, to allow the media submitter to make, via computer screen input, further additions and changes to the given media content, and to allow the media submitter to review the given media content, wherein the media content includes at least one of text and graphics to be submitted as part of the specified media layout;
a media receiver to receive the given media content into the field via the media submitter computer screen, and configured to store the given media content; and
a layout adjuster to evaluate the given media content in the field, and thereby determine space and layout requirements of the given media content, and further configured to adjust dimensions of a layout incorporating the given media content in a form that mirrors an appearance of the specified media layout upon publication.

12. The computer readable media according to claim 11, wherein the media submitter user interface is an networked user interface.

13. The apparatus according to claim 11 wherein the publisher is remote from the media submitter computer screen.

14. The apparatus according to claim 11, wherein the field is part of a fixed-size template.

15. The apparatus according to claim 11 wherein the field for holding and displaying media content for input and review is part of an ADOBE® INDESIGN® file.

16. Apparatus comprising:
a computer screen user interface;
an identification information input to receive, via the computer screen user interface, information identifying the user;
a publication selection interface presenting, for selection by the user, a list of publications wherein media content can be published;
a media category selection user interface presenting, for selection by the user, one or more categories of media content;
a classification and package user interface which indicates one or more classification for each selected category and one or more packages selectable for each classification from which a user can select the user-desired classification and package for the media content to be published;
a template selection interface which indicates one or more templates for the selected package, from which the user can select one or more to use as a template for the media content;
a media content customization interface presenting separate categories of information to be entered by the user wherein the separate categories are presented based on the media content package selected by the user and wherein the user can freely enter the media content the user wishes to publish;
a dynamic display of the layout of the media content freely entered via the media content customization interface which presents the media content as it will appear in a final publication, wherein said dynamic display incorporates changes made to the media content by the user in real-time;
a price information display wherein price information is automatically generated and displayed for each publications selected for publication of the media content based on the media content entered by the user and the publications selected, wherein such price information changes dynamically as the user changes the media content;
a proof review interface wherein the user is presented with a final graphical depiction of the media content as it will be published based on the selections made by the user and the content entered by the user, and which allows the user to accept or not accept said depiction for publication; and
a media content scheduling interface indicating, upon approval of the final graphical depiction of the media content, the publication purchase options and availability dates for the publications the user selected via the publication selection interface, wherein the user can select from the publication purchase options and from the available dates.
